(19) United States
(12) Patent Application Publication
(10) Pub. No.: US 2004/0217209 A1
(43) Pub. Date: Nov. 4, 2004

(54) Thin profile multi-function showerhead

(75) Inventor: Le Trong Bui, Garden Grove, CA (US)

Correspondence Address: FOLEY & LARDNER, 2029 CENTURY PARK EAST, SUITE 3500, LOS ANGELES, CA, 90067

(73) Assignee: INTERBATH, INC.

(21) Appl. No.: 10/411,859

(22) Filed: Apr. 11, 2003

(51) Int. Cl. B05B 1/14

(52) U.S. Cl. 239/548

(57) ABSTRACT

A showerhead includes a valve plate that is fixed in a housing and directs water received by the housing through apertures in the valve plate. A selector disk is coupled to and rotatable with respect to the valve plate. The selector disk has respective channels for conducting water from respective apertures at its rear to respective chambers at its front where different spray effects are produced. The respective apertures at the rear of the selector disk are selectably alignable to receive water from the apertures of the valve plate through rotation of the selector disk with respect to the valve plate, thereby producing the different spray effects based on the position to which the selector disk is rotated. A face plate is fixed to the selector disk and rotatable with the selector disk. The valve plate, selector disk and face plate are preferably joined by snap structures to reduce the axial length of the showerhead. The showerhead may be implemented as a stationary showerhead or a handheld showerhead.

### BACKGROUND OF THE INVENTION

1. Field of the Invention

Embodiments of the present invention pertain to plumbing fixtures, and in particular to stationary showerheads and handheld showerheads.

2. Related Technology

A conventional stationary showerhead is typically threaded to the end of a shower pipe. This design is limited in that the showerhead is usually restricted to a narrow range of motion around a ball joint connection. A more versatile design provides a handheld showerhead that is connected to the shower pipe by a flexible supply hose. The hose enables the showerhead to be handled by the user so that the water stream produced by the showerhead can be directed as the user desires. The handheld showerhead is typically provided with a mounting structure for receiving the showerhead and holding it in a stationary position from which its spray is directed.

Some showerheads, known as multi-function showerheads, provide different types of spray effects that are selectable by the user. An example of a multi-function showerhead is provided in U.S. Pat. No. 5,398,874. In that structure, a valve body is threaded to a housing. A rotating ring is coupled to valve body, a selector disk is threaded into the rotating ring, and a faceplate is threaded into the selector disk. The valve body is disposed in the path of water flow through the housing and includes a small aperture through which water may flow. The selector disk faces the valve body and has a channel for allowing passage of water through the selector disk to a pulsating spray port. By rotating the ring, the selector disk is rotated with respect to the valve plate, enabling various spray modes corresponding to different alignments of the selector disk with the valve plate. These modes include a pulsator mode in which the channel of the selector disk is aligned with the valve plate aperture, a normal spray mode where the channel of the selector disk is brought out of alignment with the valve plate aperture, causing water to flow around the selector disk and through a spray ring at the periphery of the showerhead, and an off mode in which a land on the selector disk seals the aperture in the valve plate to prevent water flow.

It is desirable to provide multiple spray effects in a handheld showerhead, however as seen in U.S. Pat. No. 5,398,874, the structure of such showerheads is complex and results in a relatively thick and heavy showerhead structure. The size and weight of stationary showerheads is of relatively little concern because stationary showerheads are mounted directly to shower pipes, however with handheld showerheads there is a greater need to reduce the thickness and weight of the showerhead so that the showerhead is lighter to hold and easier to use. It would therefore be desirable to provide a showerhead, and particularly a handheld showerhead, that provides multiple spray functions while also having a thin profile and light-weight construction.

### SUMMARY OF THE INVENTION

In accordance with embodiments of the invention, a multi-function showerhead employs a simplified internal structure that enables the showerhead to have a thinner profile. The showerhead housing includes a valve plate that is fixed in the housing and directs water received by the housing through an aperture in the valve plate. A selector disk is coupled to and rotatable with respect to the valve plate. The selector disk comprises respective channels for conducting water from respective apertures at its rear to respective chambers at the front of the selector disk where different spray effects are produced. The respective apertures at the rear of the selector disk are alignable to receive water from the aperture of the valve plate through rotation of the selector disk with respect to the valve plate, thereby producing the different spray effects based on the position to which the selector disk is rotated. A face plate is fixed to the selector disk and rotatable with the selector disk. The face plate has apertures for passing water from the respective chambers through the face plate.

In accordance with further embodiments of the invention, the major components of the showerhead are joined by snap structures rather than by threading. The elimination of threads reduces the axial length of each of the major components since the individual snap fit surfaces require significantly less height than comparable threaded surfaces.

### DESCRIPTION OF THE DRAWINGS

FIG. 1 shows a sectional view of a handheld showerhead in accordance with a preferred embodiment of the invention.

FIG. 2 shows an exploded view of the handheld showerhead of the preferred embodiment from a perspective facing a front of the showerhead; and

FIG. 3 shows an exploded view of the handheld showerhead of the preferred embodiment from a perspective facing a rear of the showerhead.

### DESCRIPTION OF PREFERRED EMBODIMENTS

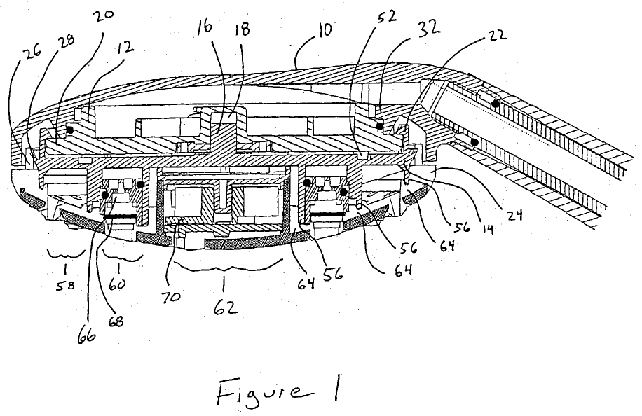

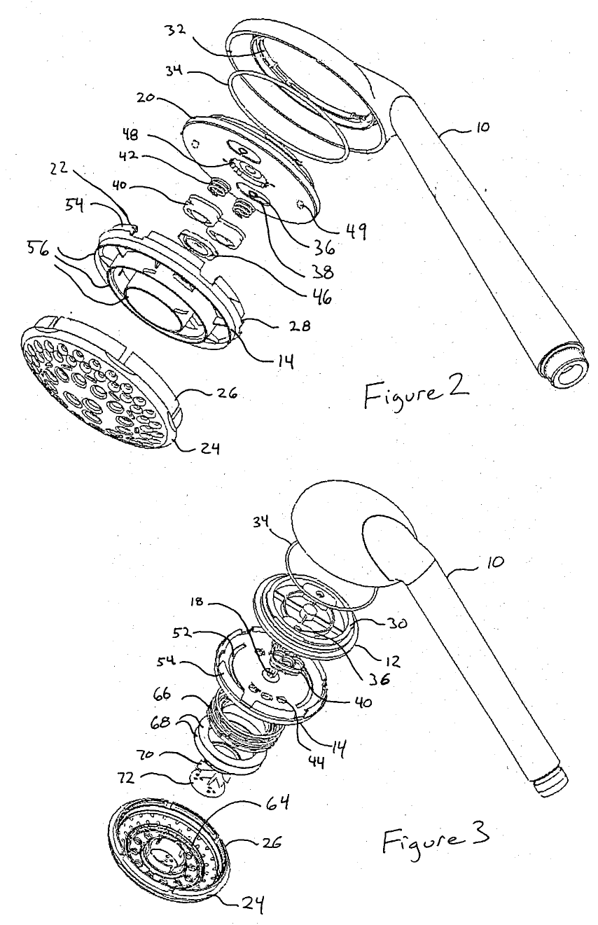

The general configuration of a preferred embodiment in accordance with the invention is first discussed with reference to FIG. 1, and details of the components of the preferred embodiment are then discussed with reference to FIGS. 1, 2 and 3. Examples of features that may be modified in alternative embodiments are then discussed.

FIG. 1 shows a sectional view of a preferred embodiment of a handheld showerhead. The showerhead comprises a housing 10 that includes a handle portion and a showerhead portion. Fixed within a front face of the housing is a valve plate 12 that includes apertures for passing water supplied through the handle of the housing 10. The valve plate 12 of the preferred embodiment is fixed to the housing by a snap structure comprising bayonet snaps, discussed further below. Coupled to and rotatable with respect to the valve plate 12 is a selector disk 14 that includes channels for directing water to various chambers on the other side of the selector disk 14 where various spray effects are produced. An axle 16 extending from the selector disk 14 is received within a corresponding recess 18 of the valve plate 12 to center the selector disk 14 with respect to the valve plate 12. The selector disk 14 is joined to the valve plate 12 at the periphery 20 of the valve plate 12 by a snap structure comprised of hook snaps 22 that engage a peripheral flange 20 of the valve plate 12 while allowing the selector disk 14 to remain rotatable with respect to the valve plate 12. Fixed to the selector disk 14 is a face plate 24 that includes apertures for passage of water spray out of the chambers formed between the face plate 24 and the selector disk 14. The face plate 24 is fixed to the selector disk 14 by a trap lock snap structure comprised of hooked tabs 26 extending from the rear of the face plate 24 that receive and engage an angled flange 28 extending from of the selector disk 14 and away from the face plate 24.

In operation, a user may change the type of spray produced by the showerhead by gripping and rotating the face plate 24. The face plate 24 is fixed to and therefore stationary with respect to the selector disk 14, and so rotation of the face plate 24 causes rotation of the selector disk 14 with respect to the valve plate 12. Rotation of the selector disk 14 causes a change in alignment between the apertures in the rear face of the selector disk 14 and the apertures in the valve plate 12, causing water to be conducted to different chambers that produce different spray effects.

Details of the components of the preferred embodiment are now discussed with references to FIGS. 1, 2 and 3. Components are discussed generally in order beginning at the showerhead housing.

The valve plate 12 is fixed to the showerhead housing 10 by bayonet snaps. Bayonet tabs 30 extend radially from the valve plate 12. The bayonet tabs 30 correspond to detents in a flange 32 that extend toward a central portion of the housing 10. When the tabs 30 are aligned with the detents they pass through the detents, allowing the valve plate 12 to be seated against the flange 32. The valve plate 12 may then be rotated to move the tabs 30 out of alignment with the recesses, causing the tabs 30 to retain the valve plate 12 against the housing 10 through engagement with a rear surface of the flange 32. In the preferred embodiment, engaging portions of the bayonet tabs 30 and the rear surface of the flange 32 are provided with complementary teeth. When the valve plate 12 is rotated, the teeth of the tabs 30 engage the teeth of the flange 32, locking the tabs 30 in position with respect to the flange 32, and thus fixing the valve plate 12 with respect to the housing 10. In the preferred embodiment, the valve plate 12 is sealed with an O-ring 34 to prevent leakage around the valve plate 12.

The valve plate 12 directs water through two apertures 36. At the front surface of the valve plate 12 are two seats 38 surrounding the apertures 36 in which cup-shaped rubber seals 40 are seated. The rubber seals 40 are biased with springs 42 to keep them pressed tightly against the rear surface of the selector disk 14, and the seals have apertures at their tips for passing water. Apertures 44 in the rear surface of the selector disk 14 conduct water through channels within the selector disk 14 to the respective chambers at the front of the selector disk 14 where different spray effects are produced. Rotation of the selector disk 14 with respect to the valve plate 12 causes different apertures 44 of the selector disk 14 to be aligned with the seals 40 to thereby conduct water through different channels to different chambers.

A click disk 46 that is stationary with respect to the axle 18 of the selector disk 14 is rotatable with the selector disk 14. Teeth of the click disk 46 engage teeth formed at the perimeter of a recess 48 in the front surface of the valve plate 12 within which the click disk 46 is disposed. When the selector disk 14 and hence the click disk 46 are rotated with respect to the valve plate 12, an audible and tactile click is produced as each tooth of the click disk 46 releases its engagement with a tooth of the recess 48. The teeth of the click disk 46 and recess 48 are arranged to produce a click each time the seals 40 become aligned respective pairs of apertures of the selector disk 14. These audible and tactile signals assist the user to rotate the selector disk 14 to appropriate positions for producing various spray effects. In addition, guide posts 49 extending from the front of the valve plate 12 are received by channels 52 formed in the rear surface of the selector disk 14. The engagement of the guide posts 49 and the channels 52 limits the range of rotation of the selector disk 14 with respect to the valve plate 12.

The selector disk 14 is rotatably coupled to the valve plate 12 by hook snaps 22 provided on support tabs 54 that extend from the rear face of the selector disk 14 to engage a peripheral flange 20 of the valve plate 12. The support tabs 54 are of a length such that they firmly engage the peripheral flange 20 of the valve plate 12 while remaining slidable around the periphery of the valve plate 12.

Extending from the front of the selector disk 14 are three concentric walls 56 that divide the forward portion of the showerhead into three separate chambers 58, 60, 62 in which three different spray effects are produced. The channels formed within the selector disk 14 conduct water from the apertures 44 at the rear of the selector disk to corresponding chambers 58, 60, 62 at the front of the selector disk 14. The ends of the walls 56 are seated in rubberized seals 64 formed on the rear surface of the face plate 24 to provide a water-tight seal between the chambers.

In the preferred embodiment, an outermost chamber 58 provides a normal type spray. Water entering this chamber passes through apertures that are aligned with corresponding apertures in the face plate. The next outermost chamber 60 provides an aerated spray. Water entering this chamber passes through an accelerator 66 that has small apertures for increasing the velocity of the water, causing air to be drawn along with the water stream. The accelerated water and air then pass through a screen assembly 68 where the water and air are mixed, and the aerated water then leaves the showerhead through corresponding apertures in the face plate 24. A central chamber 62 provides a pulsating massage spray. Water entering this chamber encounters a blade 70 that rotates under the force of the water passing through the chamber. A stream straightener 72 located at the front of the innermost chamber contains apertures for channeling the water into a clear laminar jet. The rotating blade 70 produces breaks in the water stream while the stream straightener 72 streamlines the water as it leaves the chamber, producing a water stream having a forceful pulsating effect.

The face plate 24 is fixed to the selector disk 14 by trap locks comprised of hooked tabs 26 extending from the rear of the face plate 24 that receive and engage an angled flange 28 extending from the selector disk 14 and away from the face plate. In the preferred embodiment the face plate 24 is comprised of a rigid portion and a rubberized portion. The rigid portion provides the main structure of the face plate, including the hooked tabs 26 of the trap locks. The rubberized portion is formed on the front and rear faces of the face plate 24 to provide the seals for engaging the concentric rings 56 of the selector ring 14, as well as to provide rubberized spray nipples at the front of the face plate 24 and a rubberized grip around the periphery of the face plate 24.

During assembly, the valve plate 12 is fixed in the housing 10 using the toothed bayonet tabs 30 of the valve plate 12 to engage teeth on the flange 32 of the housing 10. The seals 40 and springs 42 are then seated in the recesses 38 of the valve plate 12, the click ring 46 is mounted to the axle of the selector disk 14, and the selector disk 14 is snapped to the valve plate after being properly oriented so that the guide elements 48 on the valve plate 12 are received by the corresponding channels 52 in the rear of the selector disk 14. Structures are then mounted in the chambers 58, 60, 62 of the selector disk 14 for producing different spray effects, and the face plate 24 is snapped to the selector disk 14. The use of snap structures for coupling the main components of the showerhead allows assembly to be completed quickly and at low cost.

It may be seen in the sectional view of FIG. 1 that the design of the preferred embodiment yields a showerhead with a very thin front-to-back profile. This is enabled in part by connecting the selector disk 14 directly to the valve plate 12 and connecting the face plate 24 directly to the selector disk 14. The thin profile is further enabled by the use of snap fixtures rather than threaded fixtures for connecting the main structural components of the showerhead. Inspection of the showerhead disclosed in U.S. Pat. No. 5,398,874 shows that a significant amount of front-to-back space is required to accommodate the threaded coupling used in that design as well as to accommodate the structure required to provide a control ring in addition to a selector disk and face plate. Through elimination of threaded fixtures and a separate control ring, significant space is saved.

In operation, water is conducted from a supply hose to an inlet end of the housing 10. Water within the housing encounters the valve plate 12 where it is forced to pass through the valve plate apertures 36 and into the seals 40 seated on the opposite side of the valve plate 12. Water exiting the seals 40 is directed into apertures 44 in the rear of the selector disk 14 that are aligned with the seals 40 through rotation of the selector disk 14 into an appropriate position. Channels within the selector disk 14 conduct the water from the apertures to corresponding chambers 58, 60, 62 at the front of the selector disk 14 where different spray effects are produced. Water leaves the chambers 58, 60, 62 through apertures in the face plate 24.

While the showerhead structure illustrated herein represents a presently preferred embodiment of the invention, a variety of alternative embodiments may be implemented within the scope of the invention. For example, while the preferred embodiment is implemented as a handheld showerhead, alternative embodiments may be implemented as a stationary showerhead in which the housing includes a shower pipe adapter such as a threaded ball joint for coupling the showerhead to a shower pipe.

Further, while specific types of snap structures are used for coupling each of the major showerhead components, the particular types of snap structures may be varied depending on the implementation. In general it is only necessary that the snap structures provide either fixed or rotational coupling as needed. Further, while the preferred embodiment uses snap structures exclusively for coupling each of the major showerhead components, in other embodiments the snap structures may be replaced by other joining structures, although the replacement structures preferably have a short length in the axial direction so as to maintain the thin profile of the showerhead.

Although the preferred embodiment provides three chambers producing three different and individually selectable spray effects, in alternative embodiments different types and other numbers of spray effects may be provided. In addition, the selector disk and valve plate may be structured so that multiple spray effects can be produced simultaneously, and so that all spray is turned off. Further, the spray producing structures need not be implemented as concentric chambers, but may be arranged in other manners at the front of the showerhead.

The structure of the selector disk may also be implemented in alternative manners. While the preferred embodiment utilizes channels within the selector disk that conduct water from apertures at the rear of the selector disk to chambers at different locations at the front of the selector disk, in other embodiments the channels may be implemented as simple apertures or as other structures conducting water to corresponding chambers as necessary.

In addition, while the preferred embodiment uses spring-biased cup-shaped seals for conveying water from the valve plate to the selector disk, in alternative embodiments the seals may be implemented in other manners, such as by O-rings received in channels that surround the valve plate apertures.

The components of the showerhead may be fabricated from a variety of materials. In accordance with the preferred embodiment, the rigid components of the showerhead are injection molded using a plastic material. In other embodiments, these components may be formed of a corrosion-resistant metal such as chromium alloy-plated brass.

In handheld embodiments, the handheld showerhead may be assembled with a supply hose having an adapter for coupling to a shower pipe, and a mounting structure that is mountable to the shower pipe and comprises a cradle for receiving the showerhead.

It will be apparent to those having ordinary skill in the art that the structures described herein are not necessarily exclusive of other structures, but rather that further structures and structural features may be incorporated into the above structures in accordance with the particular implementation to be achieved. Therefore, while the embodiments illustrated in the FIGUREs and described herein are presently preferred, it should be understood that these embodiments are offered by way of example only. The invention is not limited to a particular embodiment, but extends to various modifications, combinations, and permutations that are encompassed by the claims and their equivalents.

What is claimed is:

1. A showerhead, comprising:
a housing having an inlet end for receiving water;
a valve plate fixed in the housing to direct water received by the housing through an aperture in the valve plate;
a selector disk coupled to and rotatable with respect to the valve plate, the selector disk comprising respective channels for conducting water from respective apertures at the rear of the selector disk to corresponding chambers at the front of the selector disk, the respective apertures at the rear of the selector disk being selectably alignable to receive water from the aperture of the valve plate through rotation of the selector disk with respect to the valve plate; and
a face plate fixed to the selector disk and having apertures for passing water from the respective chambers through the face plate.

2. The showerhead claimed in claim 1, wherein the housing comprises an adapter for coupling the inlet end of the housing to a shower pipe

3. The showerhead claimed in claim 1, wherein the housing comprises a handle portion and a showerhead portion, and
wherein the valve plate is fixed within the showerhead portion of the housing.

4. The showerhead claimed in claim 3, further comprising a supply hose coupled at one end to the inlet end of the housing at the handle of the housing and having a shower pipe adapter at its other end.

5. The showerhead claimed in claim 4, further comprising a mounting structure that is mountable to a shower pipe and comprises a cradle for receiving the showerhead.

6. The showerhead claimed in claim 1, wherein the valve plate is fixed in the housing by a snap structure.

7. The showerhead claimed in claim 6, wherein the snap structure fixing the valve plate in the housing comprises bayonet tabs received behind a flange of the housing.

8. The showerhead claimed in claim 7, wherein the bayonet tabs include teeth for engaging corresponding teeth at a rear surface of the flange.

9. The showerhead claimed in claim 1, further comprising a seal provided between the valve plate and the selector disk for sealing a connection between the aperture of the valve plate and an aperture at the rear of the selector disk.

10. The showerhead claimed in claim 1, wherein the selector disk is coupled to the valve plate by a snap structure.

11. The showerhead claimed in claim 10, wherein the snap structure coupling the selector disk to the valve plate comprises hooks extending from the selector disk that engage a periphery of the valve plate.

12. The showerhead claimed in claim 1, further comprising walls extending between a front the selector disk and the face plate to form said chambers between the selector disk and the face plate.

13. The showerhead claimed in claim 12, wherein a rear surface of the face plate includes rubber seals for receiving the walls extending between the selector disk and the face plate to seal the respective chambers.

14. The showerhead claimed in claim 12, wherein the walls form concentric chambers.

15. The showerhead claimed in claim 1, wherein each of the chambers produces a different spray effect for water passing through the chamber.

16. The showerhead claimed in claim 15, wherein one of said chambers produces a pulsating spray effect.

17. The showerhead claimed in claim 15, wherein one of said chambers produces an aerated spray effect.

18. The showerhead claimed in claim 1, wherein the face plate is coupled to the selector disk by a snap structure.

19. The showerhead claimed in claim 18, wherein the snap structure coupling the face plate to the selector disk is a trap lock comprised of hooks extending from the face plate that engage an angled flange extending from the selector disk in a direction away from the face plate.

20. The showerhead claimed in claim 1, wherein the face plate comprises a rubber ring at a periphery of the face plate.

21. The showerhead claimed in claim 1, wherein the face plate comprises rubber spray nipples at said apertures for passing water through the face plate.

22. The showerhead claimed in claim 1, wherein the valve plate comprises a plurality of apertures and the selector comprises a plurality of sets of corresponding apertures for sets of corresponding channels.

23. A showerhead, comprising:
a housing having an inlet end for receiving water;
a valve plate fixed in the housing by a first snap structure to direct water received by the housing through at least one aperture in the valve plate;
a selector disk coupled to the valve plate by a second snap structure and rotatable with respect to the valve plate for directing water from the at least one aperture of the valve plate to respective chambers producing respective spray effects at a front of the selector disk in accordance with a position of the selector disk; and
a face plate fixed to the selector disk by a third snap structure and having apertures for passing water from the respective chambers through the face plate.

24. The showerhead claimed in claim 23, wherein the selector disk comprises respective channels for conducting water from respective apertures at the rear of the selector disk to respective chambers at the front of the selector disk, the respective apertures at the rear of the selector disk being selectably alignable to receive water from the at least one aperture of the valve plate through rotation of the selector disk with respect to the valve plate.

25. The showerhead claimed in claim 23, further comprising walls extending between the selector disk and the face plate to form said chambers between the selector disk and the face plate.

26. The showerhead claimed in claim 25, wherein a rear surface of the face plate includes rubber seals for receiving the walls extending between the selector disk and the face plate to seal the respective chambers.

27. The showerhead claimed in claim 23, wherein the showerhead is a handheld showerhead.

28. The showerhead claimed in claim 23, wherein the showerhead is a stationary showerhead.
